(19) United States
(12) Patent Application Publication
(10) Pub. No.: US 2007/0236773 A1
(43) Pub. Date: Oct. 11, 2007

(54) High-resolution scanning display system

(76) Inventor: Shaoher X. Pan, San Jose, CA (US)

Correspondence Address: FISH & RICHARDSON P.C., PO BOX 1022, MINNEAPOLIS, MN, 55440-1022, US

(21) Appl. No.: 11/400,687

(22) Filed: Apr. 6, 2006

(51) Int. Cl. G02B 26/00

(52) U.S. Cl. 359/291

(57) ABSTRACT

A display system includes one or more rows of tiltable micro mirrors, each of which is configured to be selectively tilted to an “on” position to reflect incident light in an “on” direction and to be selectively tilted to an “off” position to reflect incident light in an “off” direction; and an optical projection system configured to project light reflected by the micro mirrors in the “on” direction to produce one or more first lines of image pixels along a first direction in a display image and to change the direction of the light reflected by the micro mirrors in the “on” direction to produce one or more second lines of image pixels in the display image. The one or more second lines of image pixels are substantially parallel to the one or more first lines of image pixels.

### BACKGROUND

The present disclosure relates to spatial light modulators.

A micro mirror array is a type of spatial light modulator (SLM) that includes an array of cells, each of which includes a mirror plate that can tilt about an axis and, furthermore, circuitry for generating electrostatic forces that can tilt the micro mirror plate. In a digital mode of operation, for example, the mirror plate can be tilted to stop at two positions. In an “on” position, the micro mirror reflects incident light toward a display surface to form an image pixel in an image display. In an “off” position, the micro mirror directs the incident light away from the image display.

FIG. 1 is a schematic diagram of a conventional display device 100 implementing a two-dimensional (2D) micro mirror array. The display device 100 includes a spatial light modulator 110 mounted on a support plate 115, and a light source system 130. The spatial light modulator 110 includes a 2D array of micro mirrors that tilt to different directions under electronic control. The light source system 130 includes an arc lamp 131, a condenser lens 132, a fold mirror 133, a UV/IR filter 134, a solid light pipe 135, a color wheel 136 mounted on a motor 137, a fold mirror 138, and a relay lens 139. The light emitted from the arc lamp 131 is reflected by a parabolic mirror to produce a collimated light beam 120. The collimated light beam 120 is directed by the condenser lens 132 and reflected by the fold mirror 133. The collimated light beam 120 passes through the UV/IR filter 134, the solid light pipe 135, and then through the spinning color wheel 136. The color wheels include segments of red, green, and blue filters that can alternately filter the collimated light beam 120 to produce different colored light beams 121. The colored light beam 121 is reflected by a fold mirror 138 and then passes through a relay lens 139 to illuminate the micro mirrors in the spatial light modulator 110.

Each micro mirror in the 2D micro mirror array in the light modulator 110 can tilt to an “on” position and an “off” position. The color light beams 140 reflected by the mirrors in the “on” positions are directed toward a display surface to form a two dimensional image. The color light beams 150 reflected by the mirrors in the “off” positions will be absorbed by a light absorber. Each image pixel in the display image is produced by a unique micro mirror in a two dimensional mirror array, that is, a displayed image pixel is correlated with a micro mirror. Thus the number of rows and the number of columns of micro mirrors the 2D micro mirror array are respectively the same as the number of horizontal and vertical image lines in the display image.

### SUMMARY

In a general aspect, the present invention relates to a display system that includes one or more rows of tiltable micro mirrors, each of which is configured to be selectively tilted to an “on” position to reflect incident light in an “on” direction and to be selectively tilted to an “off” position to reflect incident light in an “off” direction; and an optical projection system configured to project light reflected by the micro mirrors in the “on” direction to produce one or more first lines of image pixels along a first direction in a display image and to change the direction of the light reflected by the micro mirrors in the “on” direction to produce one or more second lines of image pixels in the display image. The one or more second lines of image pixels are substantially parallel to the one or more first lines of image pixels.

In another general aspect, the present invention relates to a display system that includes one or more rows of tiltable micro mirrors, each of which is configured to be selectively tilted to an “on” position to reflect incident light toward an “on” direction and to be selectively tilted to an “off” position to reflect incident light toward an “off” direction; a projection device configured to project light reflected by the micro mirrors in the “on” direction to produce one or more first lines of image pixels along a first direction in a display image; and a transport mechanism configured to rotate the projection device to change the direction of the light reflected by the micro mirrors in the “on” direction to a plurality of directions such that a plurality of sets of one or more second lines of image pixels are formed substantially parallel to the one or more first lines of image pixels.

In yet another general aspect, the present invention relates to a display system that includes one or more rows of tiltable micro mirrors, each of which is configured to be tilted by an electrostatic force about an axis substantially perpendicular to the row direction of the one or more rows of tiltable micro mirrors, wherein the tiltable micro mirror is configured to be selectively tilted to an “on” position to reflect incident light toward an “on” direction and to be tilted to an “off” position to reflect incident light toward an “off” direction; a projection device configured to project light reflected by the micro mirrors in the “on” direction to produce one or more first lines of image pixels along a first direction in a display image; and a transport mechanism configured to rotate the projection device to change the direction of the light reflected by the micro mirrors in the “on” direction to a plurality of directions such that a plurality sets of one or more second lines of image pixels are formed substantially parallel to the one or more first lines of image pixels.

Implementations of the system may include one or more of the following. The plurality of sets of one or more second lines of image pixels can be displaced from the one or more first lines of image pixels in a second direction substantially perpendicular to the first direction. The plurality of sets of one or more second lines of image pixels and the one or more first lines of image pixels can form a two-dimensional array of image pixels in the display image. The optical projection system can include a polygon that comprises one or more reflective surfaces configured to reflect the light reflected by the micro mirrors in the “on” direction to form the one or more first lines of image pixels along the first direction in the display image. The optical projection system can further include a transport mechanism configured to rotate the polygon about a rotational axis to change the direction of reflected light to produce a plurality of sets of one or more second lines of image pixels in the display image. The rotational axis of the polygon can be substantially parallel to the first direction. At least one of the titlable micro mirrors can be configured to tilt about an axis substantially perpendicular to the row direction of the one or more rows of tiltable micro mirrors. At least one of the tiltable micro mirrors can include a mirror plate and two hinges that are in connection with the mirror plate and with a substrate. The mirror plate can be configured to be tilted by an electrostatic force about an axis defined by the two hinges. The hinges can be hidden behind the mirror plate from the incident light. The hinges can be at least partially exposed to the incident light. At least one of the tiltable micro mirrors can include a mirror plate having a reflective surface configured to reflect the incident light toward the “on” direction. The mirror plate can be rectangular shaped, square shaped, or diamond shaped. A narrow dimension of the rectangular shaped mirror plate can be aligned along the row direction of the one or more rows of tiltable micro mirrors. A diagonal line of the diamond-shaped mirror plate or the square-shaped mirror plate can be aligned along the row direction of the one or more rows of tiltable micro mirrors.

The disclosed display system can include one or more of the following advantages. The disclosed display system can include a spatial light modulator based on one or a small number of rows of micro mirrors. Two-dimensional images can be formed by scanning the light reflected by the one or more rows of micro mirrors in the spatial light modulator. The number of rows (e.g. fewer than 10 rows) of micro mirrors in the disclosed spatial light modulator is much fewer than the rows of pixels in the display image. In a conventional micro-mirror based display device, for comparison, each image pixel in a display image is uniquely correlated with a micro mirror in a 2D mirror array. The number of rows of micro mirrors in the conventional display device is thus substantially the same as the number of horizontal image lines (e.g. in 1000's) in the display image. The much fewer rows of micro mirrors allow the disclosed spatial light modulator to be more easily manufactured than the conventional micro-mirror-based display systems.

Another potential advantage of the disclosed display system is that the aspect ratio of the display image can be easily varied. An optical projection system in the disclosed display system can scan the reflected light across the display surface to form a plurality of parallel lines of image pixels, thus forming a two dimensional display image. The image dimension in the scanning direction can be varied by controlling the scanning range of the optical projection system without changing the physical configuration of the disclosed display system.

Yet another potential advantage of the disclosed display system is that it allows the size and the resolution of the display image to be more easily scaled up compared to conventional spatial light modulators based on 2D array of micro mirrors. The image dimension of the display image in the scanning direction can be increased without additional physical components, as described above. The number of micro mirrors within rows of mirrors can be increased with incremental manufacturing complexity because of the few rows of micro mirrors involved. More micro mirrors in the one or more rows can produce a larger number of image pixels along the image dimension perpendicular to the scanning direction. Thus both dimensions of the display image can be increased at a small or incremental manufacturing complexity.

Although the invention has been particularly shown and described with reference to multiple embodiments, it will be understood by persons skilled in the relevant art that various changes in form and details can be made therein without departing from the spirit and scope of the invention.

### BRIEF DESCRIPTION OF THE DRAWINGS

The following drawings, which are incorporated in and form a part of the specification, illustrate embodiments of the present invention and, together with the description, serve to explain the principles, devices and methods described herein.

FIG. 1 is a schematic diagram of a conventional display system.

FIG. 2a is a schematic view, partially perspective and partially block diagram, of a scanning display system.

FIG. 2b is a schematic side view of the scanning display system in FIG. 2a.

FIGS. 3a-3d are detailed views of the one implementations of the spatial light modulator compatible with the scanning display system of FIG. 2a.

FIG. 4 is an exemplified cross-section view of a micro mirror along the line A-A in FIG. 3a.

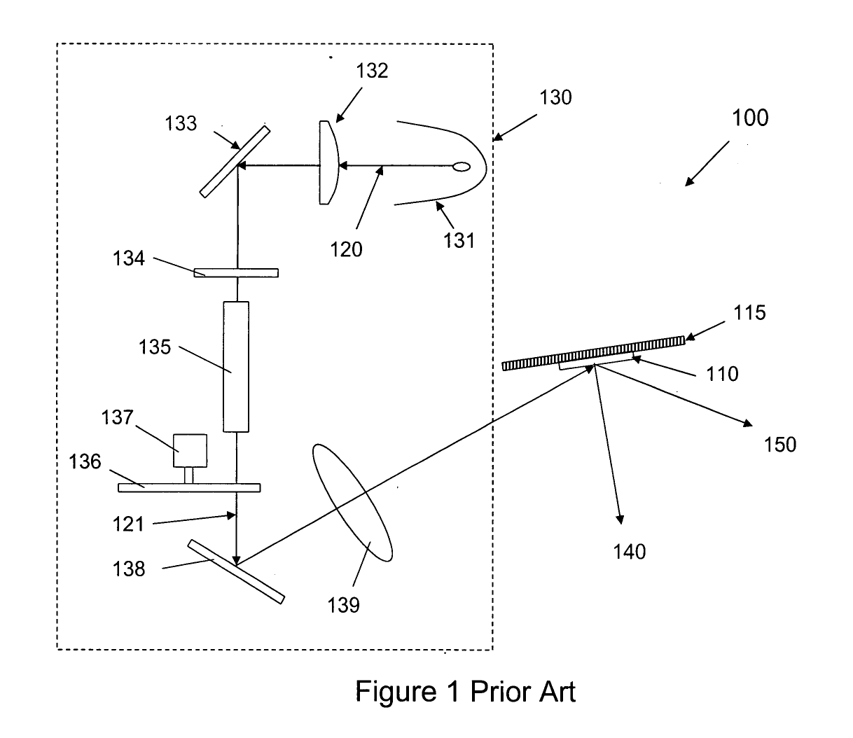

### DETAILED DESCRIPTION

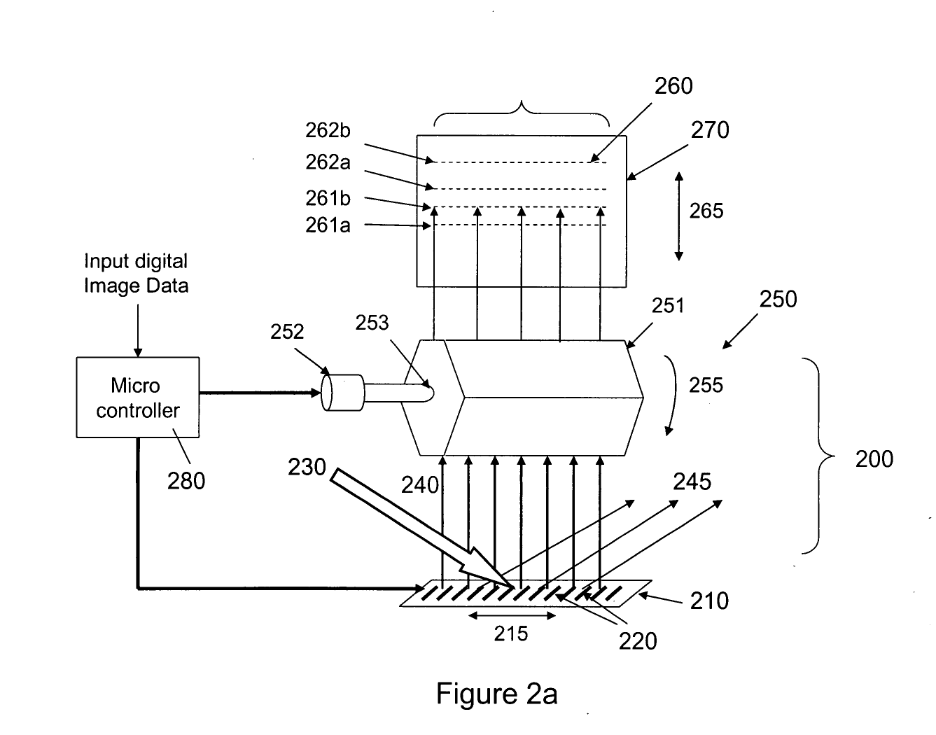

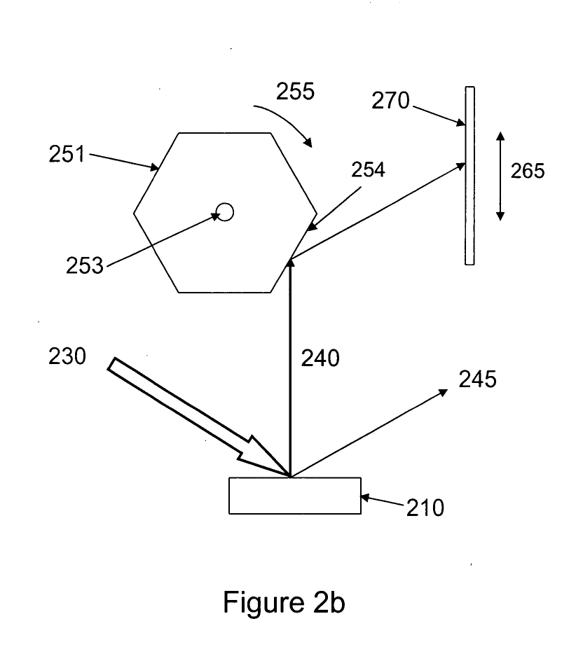

FIG. 2a is a schematic view, partially perspective and partially block diagram, of a scanning display system 200. FIG. 2b is a schematic side view of the scanning display system 200. The scanning display system 200 includes a spatial light modulator 210 and an optical projection system 250. The spatial light modulator 210 includes a plurality of tiltable micro mirrors 220 that are distributed in one or more rows along a lateral direction 215. The spatial light modulator 210 typically includes a small number of rows (for example, less than 10 rows) of tiltable micro mirrors 220. In particular, the number of rows of micro mirrors in the spatial light modulator 210 is much smaller than the number of rows of pixels in a typical display image to be produced by the scanning display system 200.

As described in more detail below, the tiltable mirrors 220 can be individually addressed to tilt in two or more directions by a micro controller 280. The micro mirrors 220 can tilt to the “on” positions to reflect incident light 230 to produce reflected light 240 in the “on” direction. Alternatively, the incident light 230 can be directed by the micro mirrors 220 in the “off” positions to produce reflected light 245 in the “off” direction. The light 245 can subsequently be absorbed by a light absorber (not shown) to prevent flare light. The incident light 230 can be produced by various light sources, such as a light emitting diode (LED) or an arc lamp.

The micro controller 280 receives input image data, such as video data including a series of image frames. The micro controller 280 controls the orientations of the tiltable mirrors 220 to the “on” or “off” positions in accordance with the pixel values at a line of image pixels in the input digital image. The light 240 reflected by the “on” micro mirrors 220 is projected by the optical projection system 250 to a display area 270. The display area 270 can, for example, be on a projection screen, a white board, a glass pane, a wall, or a virtual image. The projected light forms a line of image pixels 261a on the display area 270 in accordance with the pixel values in a line of image pixels in the input digital image.

In one implementation, the optical projection system 250 includes a polygon 251 that includes one or more reflective flat surfaces 254. The flat polygon surfaces 254 can reflect the light 240 toward a display area 270 to form an image on the display area 270. The polygon 251 can be made of glass, metal, or plastic. The polygon surfaces 254 can be coated with a thin layer of reflective metal such as aluminum. The polygon surfaces 254 are required to be flat within a tolerance such that the image pixels can be formed uniformly on the display area 270. For example, one criterion for the flatness of the polygon surfaces 254 is that the distortions of image pixel locations in the displayed image on the display area 270 should be less than ½ the width of an image pixel. Another criterion on the roughness of the polygon surfaces 254 should be smaller than one or a fraction of a wavelength of visible light over the illuminated area of a polygon surface 254.

The optical projection system 250 also includes a transport mechanism 252 that can rotate the polygon 251 about a rotational axis 253. In one implementation, the transport mechanism 252 includes a motor that is under the control of the micro controller 280. The motor can be a DC motor or a digital stepper motor. The micro controller 280 controls the transport mechanism 252, which in turn rotates the polygon 251 about the rotational axis 253 in synchronization with the modulation of the micro mirrors 220. The rotated polygon 251 changes the directions of the light reflected by the polygon 251, such that the light projected onto the display area 270 is scanned along a vertical direction 265. In one implementation, the rotational axis 253 of the polygon 251 can be substantially perpendicular to the vertical direction 265 and substantially parallel to the lines of image pixels 261a, 261b, 262a, and 262b. In some implementations, the polygon 251 rotates in a single direction, such as clockwise 255 or counterclockwise.

As the polygon 251 rotates through different angular positions, the micro controller 280 controls the micro mirrors 220 to the “on” or “off” positions in accordance with corresponding pixel values at a horizontal line of image pixels in the input digital image. At one angular position, the micro mirror can form a line of image pixels 261 a in the display area 270. However, as the polygon 251 rotates to different angular positions, different lines of image pixels 261b, 262a, 262b, etc., are formed in the display area 270. The lines of image pixels 261a can be formed in progressive or interlaced fashion. The lines of image pixels 261a, 261b, 262a and 262 can together form a 2D display image 260 in the display area 270.

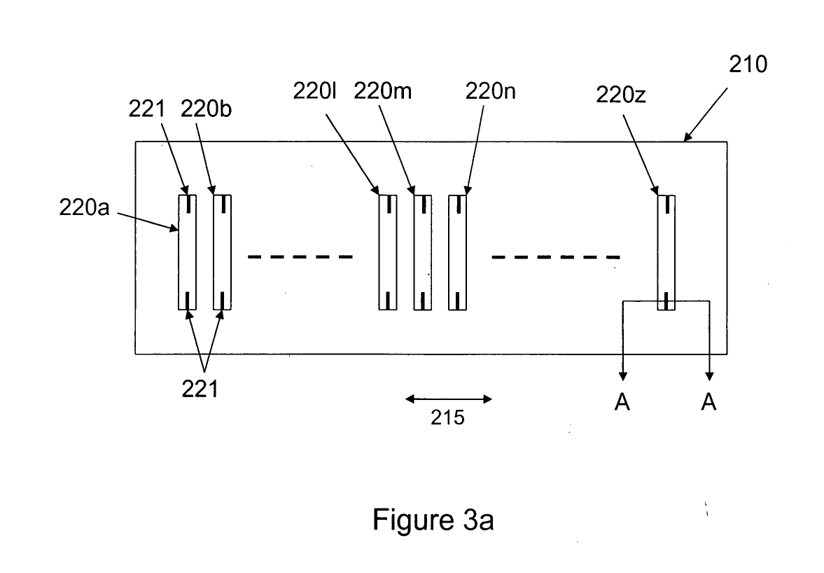

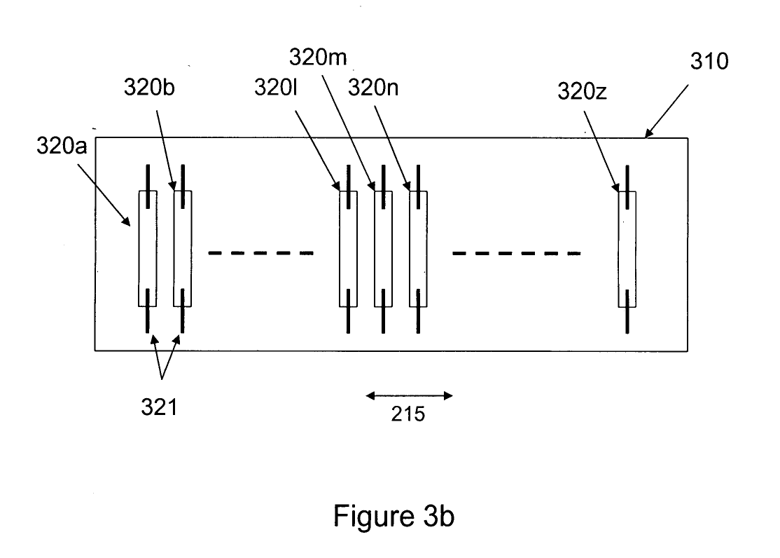

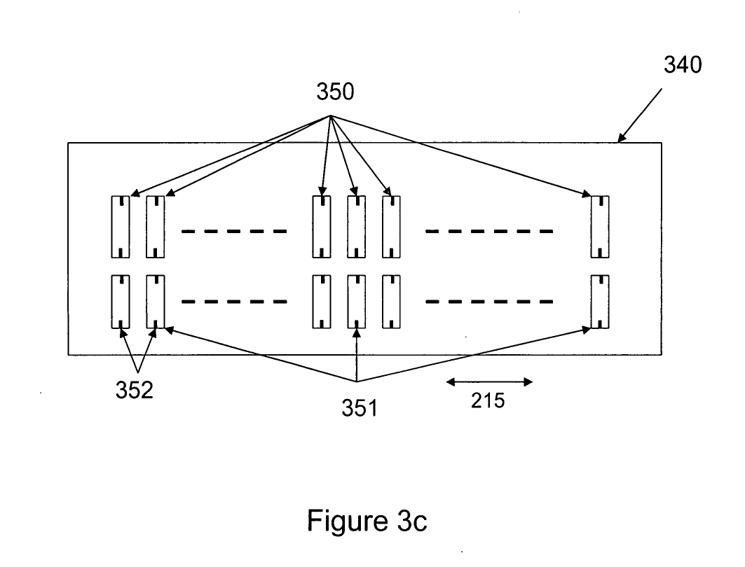

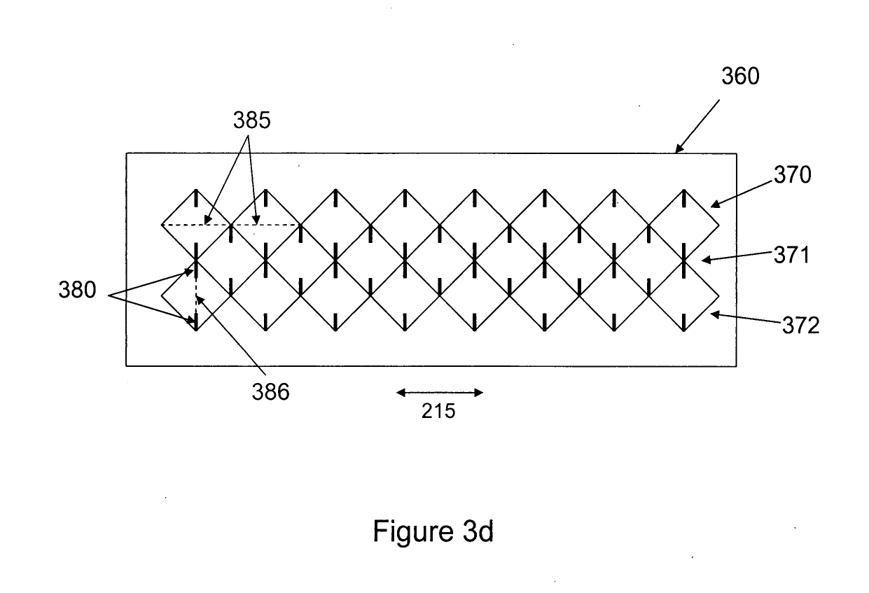

FIG. 3a is a detailed view of an example of the spatial light modulator 210 compatible with the scanning display system 200. The spatial light modulator 210 includes a plurality of micro mirrors 220a to 220z distributed in one dimensional (1D) array along the lateral direction 215. In one implementation, the micro mirrors 220a-220z are rectangular shaped, with their widths narrower than their lengths. The narrow dimensions of the micro mirrors 220a-220z are aligned along the lateral direction 215 to maintain a high density of micro mirrors 220a-220z in the spatial light modulator 210 (which enables the formation of a high resolution display image in the display area 270). The long dimensions of the micro mirrors 220a-220z increase the mirror areas and thus the amount of the light reflected by the micro mirrors 220a-220z.

The micro mirrors 220a-220z can be hinged at hinges 221 at the ends of the long dimensions of the mirrors. The hinges 221 act as pivot points that define rotational axes for the micro mirrors' tilt movements. In one implementation, as shown in FIG. 3a, the hinges 221 are hidden under the mirror plates. In another implementation, as shown in FIG. 3b, the hinges 321 for the micro mirrors 320a-320z in the spatial modulator 310 are at least partially exposed outside of their respective mirror plates.

In another implementation, shown in FIG. 3c, the spatial light modulator 340 includes two rows of micro mirrors 350 and 351, both distributed in the lateral direction 215. The micro mirrors 350 and 351 can be rectangular, square, or of other shapes. The hinges 352 can be hidden as shown in FIG. 3c or exposed. The spatial light modulator 340 is capable of simultaneously displaying two lines of image pixels 261a and 261b on the display surface 270 at each projected direction by the polygon 251. As the polygon 251 rotates to a different angular direction, the polygon 251 directs the light 240 to the display surface 270 to form two different lines of image pixels 262a and 262b. To avoid smearing between adjacent lines of image pixels, the polygon 251 can be rotated by a stepper motor. The polygon 251 can be held for a short line time for forming each pair of image pixel lines. When the polygon 251 rotates from one angular position to the next angular position, the incident line 230 can briefly be deflected away for the display surface 270 to produce light 245.

In yet another implementation, FIG. 3d depicts an example of a spatial light modulator 360 that includes three rows of micro mirrors 370, 371, and 372 that are distributed in the lateral direction 215. The micro mirrors 370, 371, and 372, as shown, have diamond or square shapes. One diagonal line 385 of a micro mirror 370, 371, or 372 is parallel to the lateral direction 215. The hinges 380 of the micro mirror can be located at two opposite corners of the diamond-shaped or square-shaped micro mirror. The hinges 380 act as pivot points for the micro mirror 370, 371 or 372 to allow the mirror plate to tilt about an axis 386 defined by the two hinges 380. In the configuration shown in FIG. 3d, the axes of rotation for the micro mirrors 370, 371 or 372 are perpendicular to the lateral direction 215.

An example of the operation of the scanning display system 200 is now described. The spatial light modulator 210 can include 4000 micro mirrors in a 1D mirror array as shown in FIG. 3a. Thus each image line 261a, 261b, 262a or 262b includes 4000 image pixels. Each of the image lines 261a, 261b, 262a and 262 corresponds to a particular reflective orientation of the polygon 251. The scanning display system 200 can be configured to provide a display image that is 4000 pixels wide and 2000 pixels high in the display area 270. To provide a monochrome video display at a bit depth of 8 bits and a frame rate of 60 Hz, the shortest “on” time for a micro mirror (also referred as Least Significant Bit) is

$$LSB = 1 / ( ( bit depth ) \times ( frame rate ) \times ( number of color planes ) \times ( number of image rows ) ) = 1 / ( 256 \times 60 Hz \times 2000 ) = 0.033 micro second . \qquad Eqn . ( 1 )$$

To provide a color video display at the same conditions, the shortest “on” time for a micro mirror is thus 0.011 micro second.

In another example of the operation of the scanning display system 200, the spatial light modulator 210 as shown in FIG. 3d includes three rows of 4000 micro mirrors. The scanning display system 200 can be configured to produce a display image that is 4000 pixels wide and 2000 pixels high. Three lines of image pixels can be simultaneously displayed by the three rows of micro mirrors 370, 371, and 372. To provide a monochrome video display at a bit depth of 8 bits and a frame rate of 60 Hz, the shortest “on” time for a micro mirror is

$$LSB = 1 / ( ( bit depth ) \times ( frame rate ) \times ( number of color planes ) \times ( number of image rows ) / ( number of mirror rows ) ) = 1 / ( 256 \times 60 Hz \times 2000 / 3 ) = 0.1 micro second . \qquad Eqn . ( 2 )$$

Similarly, to provide a color video display using the three rows of mirrors and otherwise the same conditions, the shortest “on” time for a micro mirror is thus 0.033 micro second. The requirement on the rates of the mirror tilt movement is relaxed compared to the spatial light modulator shown in FIG. 3a.

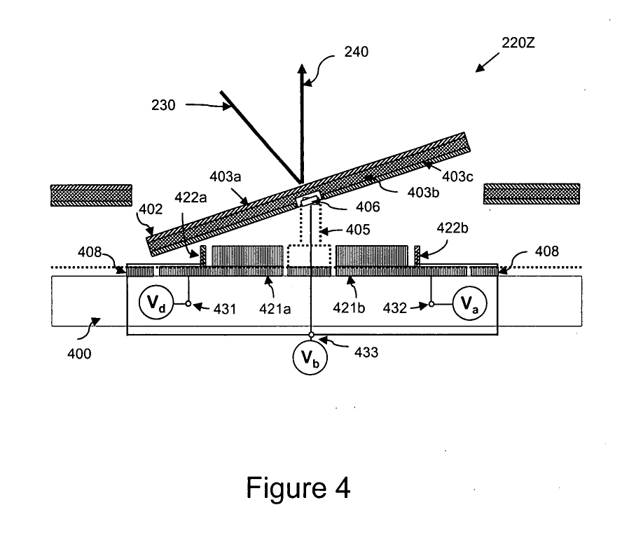

FIG. 4 illustrates an exemplified detailed structure for the micro mirror 220Z. In a cross-sectional view along line A-A in FIG. 3a, the micro mirror 220Z includes a mirror plate 402 that includes a flat reflective upper layer 403a that provides the mirror surface, a middle layer 403b that provides the mechanical strength to the mirror plate, and a bottom layer 403c. The upper layer 403a can be realized by a reflective material, typically, a thin reflective metallic layer. For example, aluminum, silver, or gold can be used to form the upper layer 403a. The layer thickness can be in the range of 200 to 1000 angstroms, such as about 600 angstroms. The middle layer 403b can be made of a silicon based material, for example, amorphous silicon, typically about 2000 to 5000 angstroms in thickness. The bottom layer 403c can be built by an electrically conductive material that allows the electric potential of the bottom layer 403c to be controlled relative to the step electrodes 421a or 421b. For example, the bottom layer 403c can be made of titanium and has a thickness in the range of 200 to 1000 angstrom.

The mirror plate 402 includes a hinge 406 that is connected with the bottom layer 403c and is supported by a hinge post 405 that is rigidly connected to a substrate 400. The mirror plate 402 can include two hinges 406 (i.e., hinge 221 in FIG. 3a) connected to the bottom layer 403c. Each hinge 406 (or 221) defines a pivot point for the mirror plate 402. The two hinges 406 (or 221) define an axis about which the mirror plate 402 can be tilted. The hinges 406 extend into cavities in the lower portion of mirror plate 403. For ease of manufacturing, the hinge 406 can be fabricated as part of the bottom layer 403c.

Step electrodes 421a and 42 lb, landing tips 422a and 422b, and a support frame 408 can also be fabricated over the substrate 400. The step electrode 421a is electrically connected to an electrode 431 whose voltage Vd can be externally controlled. Similarly, the step electrode 421b is electrically connected with an electrode 432 whose voltage Va can also be externally controlled. The electric potential of the bottom layer 403c of the mirror plate 402 can be controlled by electrode 433 at potential Vb.

The micro mirror 220Z can be selectively controlled from the group of micro mirrors 220a to 220z. Bipolar electric pulses can individually be applied to the electrodes 431, 432, and 433. Electrostatic forces can be produced on the mirror plate 402 when electric potential differences are created between the bottom layer 403c on the mirror plate 402 and the step electrodes 421a or 421b. An imbalance between the electrostatic forces on the two sides of the mirror plate 402 causes the mirror plate 402 to tilt from one orientation to another. When the mirror plate 402 is tilted to the “on” position as shown in FIG. 4, the flat reflective upper layer 402 reflects the incident light 230 to produce the reflected light 240 along the “on” direction. The incident light 230 is reflected to the “off” direction when the mirror plate 402 is tilted to the “off” position.

The multiple steps in the step electrodes 421a and 421b narrow the air gap between the mirror plate 403 and the electrodes 421a or 421b, and can increase the electrostatic forces experienced by the mirror plate 402. The height of the step electrodes 421a and 421b can be in the range from about 0.2 microns to 3 microns.

The landing tips 422a and 422b can have a same height as that of second step in the step electrodes 421a and 421b for manufacturing simplicity. The landing tips 422a and 422b provide a gentle mechanical stop for the mirror plate 402 after each tilt movement. The landing tips 422a and 422b can also stop the mirror plate 402 at a precise angle. Additionally, the landing tips 422a and 422b can store elastic strain energy when they are deformed by electrostatic forces and convert the elastic strain energy to kinetic energy to push away the mirror plate 402 when the electrostatic forces are removed. The push-back on the mirror plate 402 can help separate the mirror plate 402 and the landing tips 422a and 422b, which helps to overcome the stiction of the mirror plate to the substrate, a well known challenge for micro mirror devices.

It is understood that the disclosed systems and methods are compatible with other configurations of micro mirrors, optical scanning and projection systems, and displays without deviating from the spirit of the present invention. The micro mirrors can generally include mirrors that are made by micro-fabrication techniques and can tilt in one or more orientations under electronic control. Different light sources can be used by the disclosed display system. In addition, the parameters used above are meant to be examples for illustrating the operations of the disclosed display system. The disclosed display system can operate at different operating conditions without deviating from the spirit of the present specification. Furthermore, although FIG. 4 shows an example of a mirror plate that stop at pre-determined angles by contacting the landing tips, the disclosed display system is also compatible with non-contact micro mirrors that can tilt to different positions without contacting an object on the substrate.

It should also be understood that the display image discussed in relation with in FIGS. 2a and 2b can be aligned in different orientations relative to the viewers. For example, the disclosed display system can be configured such that the display image is 2000 pixels wide and 4000 pixels high. Furthermore, the light modulated by the spatial light modulator based on one or more rows of micro mirrors can be scanned by optical systems other than the polygon, as shown in FIGS. 2a and 2b.

What is claimed is:

1. A display system, comprising:
one or more rows of tiltable micro mirrors, each of which is configured to be selectively tilted to an “on” position to reflect incident light in an “on” direction and to be selectively tilted to an “off” position to reflect incident light in an “off” direction; and
an optical projection system configured to project light reflected by the micro mirrors in the “on” direction to produce one or more first lines of image pixels along a first direction in a display image and to change the direction of the light reflected by the micro mirrors in the “on” direction to produce one or more second lines of image pixels in the display image, wherein the one or more second lines of image pixels are substantially parallel to the one or more first lines of image pixels.

2. The display system of claim 1, wherein the optical projection system is configured to change the direction of the light reflected by the micro mirrors in the “on” direction to a plurality of directions such that a plurality of sets of one or more second lines of image pixels are formed substantially parallel to the one or more first lines of image pixels.

3. The display system of claim 2, wherein the plurality of sets of one or more second lines of image pixels are displaced from the one or more first lines of image pixels in a second direction substantially perpendicular to the first direction.

4. The display system of claim 2, wherein the plurality of sets of one or more second lines of image pixels and the one or more first lines of image pixels form a two-dimensional array of image pixels in the display image.

5. The display system of claim 1, wherein the optical projection system comprises a polygon that comprises one or more reflective surfaces configured to reflect the light reflected by the micro mirrors in the “on” direction to form the one or more first lines of image pixels along the first direction in the display image.

6. The display system of claim 5, wherein the optical projection system further comprises a transport mechanism configured to rotate the polygon about a rotational axis to change the direction of reflected light to produce a plurality of sets of one or more second lines of image pixels in the display image.

7. The display system of claim 5, wherein the rotational axis of the polygon is substantially parallel to the first direction.

8. The display system of claim 1, wherein at least one of the titlable micro mirrors is configured to tilt about an axis substantially perpendicular to the row direction of the one or more rows of tiltable micro mirrors.

9. The display system of claim 1, wherein at least one of the tiltable micro mirrors comprises a mirror plate and two hinges that are in connection with the mirror plate and with a substrate.

10. The display system of claim 9, wherein the mirror plate is configured to be tilted by an electrostatic force about an axis defined by the two hinges.

11. The display system of claim 9, wherein the hinges are hidden behind the mirror plate from the incident light.

12. The display system of claim 9, wherein the hinges are at least partially exposed to the incident light.

13. The display system of claim 1, wherein at least one of the tiltable micro mirrors comprises a mirror plate having a reflective surface configured to reflect the incident light toward the “on” direction.

14. The display system of claim 13, wherein the mirror plate is rectangular shaped, square shaped, or diamond shaped.

15. The display system of claim 14, wherein a narrow dimension of the rectangular shaped mirror plate is aligned along the row direction of the one or more rows of tiltable micro mirrors.

16. The display system of claim 14, wherein a diagonal line of the diamond-shaped mirror plate or the square-shaped mirror plate is aligned along the row direction of the one or more rows of tiltable micro mirrors.

17. A display system, comprising:
one or more rows of tiltable micro mirrors, each of which is configured to be selectively tilted to an “on” position to reflect incident light toward an “on” direction and to be selectively tilted to an “off” position to reflect incident light toward an “off” direction;
a projection device configured to project light reflected by the micro mirrors in the “on” direction to produce one or more first lines of image pixels along a first direction in a display image; and
a transport mechanism configured to rotate the projection device to change the direction of the light reflected by the micro mirrors in the “on” direction to a plurality of directions such that a plurality of sets of one or more second lines of image pixels are formed substantially parallel to the one or more first lines of image pixels.

18. The display system of claim 17, wherein the plurality of sets of one or more second lines of image pixels and the one or more first lines of image pixels form a two-dimensional array of image pixels in the display image.

19. The display system of claim 17, wherein the projection device comprises a polygon configured to be rotated by the transport mechanism, wherein the polygon comprises one or more reflective surfaces configured to reflect the light reflected by the micro mirrors in the “on” direction to form the one or more first lines of image pixels along the first direction in the display image.

20. The display system of claim 17, wherein at least one of the titlable micro mirrors is configured to tilt about an axis substantially perpendicular to the row direction of the one or more rows of tiltable micro mirrors.

21. The display system of claim 17, wherein at least one of the tiltable micro mirrors comprises a mirror plate and two hinges that are in connection with the mirror plate and with a substrate.

22. The display system of claim 21, wherein the mirror plate is configured to be tilted by an electrostatic force about an axis defined by the two hinges.

23. The display system of claim 21, wherein the hinges are hidden behind the mirror plate from the incident light.

24. The display system of claim 21, wherein the hinges are at least partially exposed to the incident light.

25. The display system of claim 17, wherein at least one of the tiltable micro mirrors comprises a mirror plate having a reflective surface configured to reflect the incident light toward the “on” direction.

26. The display system of claim 25, wherein the mirror plate is rectangular shaped, square shaped, or diamond shaped.

27. The display system of claim 26, wherein the narrow dimension of the rectangular shaped mirror plate is aligned along the row direction of the one or more rows of tiltable micro mirrors.

28. The display system of claim 26, wherein a diagonal line of the diamond-shaped mirror plate or the square-shaped mirror plate is aligned along the row direction of the one or more rows of tiltable micro mirrors.

29. A display system, comprising:
one or more rows of tiltable micro mirrors, each of which is configured to be tilted by an electrostatic force about an axis substantially perpendicular to the row direction of the one or more rows of tiltable micro mirrors, wherein the tiltable micro mirror is configured to be selectively tilted to an “on” position to reflect incident light toward an “on” direction and to be tilted to an “off” position to reflect incident light toward an “off” direction;
a projection device configured to project light reflected by the micro mirrors in the “on” direction to produce one or more first lines of image pixels along a first direction in a display image; and
a transport mechanism configured to rotate the projection device to change the direction of the light reflected by the micro mirrors in the “on” direction to a plurality of directions such that a plurality sets of one or more second lines of image pixels are formed substantially parallel to the one or more first lines of image pixels.

30. The display system of claim 29, wherein at least one of the tiltable micro mirrors comprises a mirror plate and two hinges that are in connection with the mirror plate and with a substrate, and the mirror plate is configured to be tilted by the electrostatic force about an axis defined by the two hinges.

31. The display system of claim 30, wherein the hinges are at least partially hidden behind the mirror plate from the incident light.

32. The display system of claim 29, wherein at least one of the tiltable micro mirrors comprises a mirror plate having a reflective surface configured to reflect the incident light toward the “on” direction.

33. The display system of claim 32, wherein the mirror plate is rectangular shaped, square shaped, or diamond shaped.

34. The display system of claim 33, wherein the narrow dimension of the rectangular shaped mirror plate is aligned along the row direction of the one or more rows of tiltable micro mirrors.

35. The display system of claim 33, wherein a diagonal line of the diamond-shaped mirror plate or the square-shaped mirror plate is aligned along the row direction of the one or more rows of tiltable micro mirrors.
